(19) United States
(12) Patent Application Publication
(10) Pub. No.: US 2023/0342688 A1
(43) Pub. Date: Oct. 26, 2023

(54) Charging Guidance Method For Fast Charging Loads Based On Adjustable And Graded Charging Service Fee

(71) Applicant: Shanghai University of Electric Power, Shanghai (CN)

(72) Inventors: Meixia ZHANG, Shanghai (CN); Licheng XU, Shanghai (CN); Qianqian ZHANG, Shanghai (CN); Xiu YANG, Shanghai (CN)

(21) Appl. No.: 18/105,123

(22) Filed: Feb. 2, 2023

(30) Foreign Application Priority Data
Mar. 22, 2022 (CN) 202210294593.1

(51) Int. Cl. G06Q 10/0631

(52) U.S. Cl. CPC G06Q 10/06315

(57) ABSTRACT

The present disclosure relates to a charging guidance method for fast charging loads based on an adjustable and graded charging service fee, including: establishing a fast charging load prediction model based on a trip chain and a Monte Carlo method to predict a fast charging demand and a spatial-temporal trajectory change of a user trip; deciding a charging location based on a weighted user charging location decision model, and calculating a fast charging load of each charging station; constructing a regional graded charging service fee adjustment model with a minimum sum of absolute values of voltage deviations of nodes in the distribution network in a region as an optimization objective, and optimizing and adjusting the charging service fee; and determining an optimal user charging location under fast charging loads by using the weighted user charging location decision model based on the adjusted charging service fee.

### CROSS REFERENCE TO RELATED APPLICATION

This patent application claims the benefit and priority of Chinese Patent Application No. 202210294593.1 filed with the China National Intellectual Property Administration on Mar. 22, 2022, the disclosure of which is incorporated by reference herein in its entirety as part of the present application.

### TECHNICAL FIELD

The present disclosure relates to the technical field of fast charging of electric vehicles, and in particular, to a charging guidance method for fast charging loads based on an adjustable and graded charging service fee.

### BACKGROUND

As fossil energy is being severely consumed and urban air quality is worsening, electric vehicles with clean and low-carbon performance have been vigorously promoted all over the world. The development of electric vehicles has become a key way to save energy and reduce emissions in the transportation sector, and has also become an important driving force for promoting the transformation of China’s industrial structure. However, the use of high-power fast charging piles, especially the connection of a large number of high-power fast charging devices such as Tesla Superchargers, will inevitably change load characteristics of typical distribution networks and have a greater impact on voltage quality of the distribution networks. Therefore, on the basis of scientifically and accurately predicting spatial and temporal distribution of fast charging loads in a region, it is of great significance to formulate a reasonable and effective charging service fee mechanism and guide electric vehicle users to choose public charging stations for charging by reasonable decisions, which will improve power quality of urban distribution networks and delay the expansion of distribution networks.

In existing research, with balancing of regional charging, improvement of voltage quality of distribution networks, and reduction of a peak-valley difference of distribution networks, etc. as optimization objective, different charging service fee mechanisms are constructed, and certain effects are achieved. However, in the above research, usually only individual time periods within one day are selected for simulation analysis, so that there is lack of overall consideration and research on spatial and temporal distribution of 24-hour fast charging loads resulting from adjustable charging service fees, distribution network voltage analysis, and the economy of participants.

### SUMMARY

An objective of some embodiments is to provide a method for charging guidance of fast charging loads based on an adjustable and graded charging service fee to overcome the disadvantages existing in the prior art. The method can effectively guide a user to change a charging location, thereby changing spatial and temporal distribution of fast charging loads, which is of great significance for improving voltage quality of a distribution network and reducing charging costs of the user.

The objective of some embodiments can be achieved by the following technical solutions.

The present disclosure provides a charging guidance method for fast charging loads based on an adjustable and graded charging service fee, including the following steps:
step S1: establishing, according to constraints of a regional road network and a distribution network, a fast charging load prediction model based on a trip chain and a Monte Carlo method, to predict a fast charging demand and a spatial-temporal trajectory change of a user trip;
step S2: deciding a charging location based on a weighted user charging location decision model with an objective function being a minimum comprehensive cost of a charging service fee, travel time and travel power consumption, counting a fast charging load of each charging station, calculating the fast charging loads of the charging stations under corresponding power supply nodes to calculate time sequential load flow;
step S3: constructing a regional graded charging service fee adjustment model with a minimum sum of absolute values of voltage deviations of the nodes in the distribution network in a region as an optimization objective, and optimizing and adjusting the charging service fee; and
step S4: determining an optimal user charging location under fast charging loads by using the weighted user charging location decision model based on the adjusted charging service fee.

Preferably, step S1 includes:
step S11: constructing a regional road network model R=(D,L), where D represents a set of road network nodes, L represents a set of road sections included in a road network R, and obtaining a road network weight adjacency matrix W including association state of nodes in the road network and road resistance of road sections, with an expression as follows:
$$W = \left[\begin{matrix}0 & {w}_{{d}_{1} {d}_{2}} & {w}_{{d}_{1} {d}_{3}} & {w}_{inf} \\ {w}_{{d}_{2} {d}_{1}} & 0 & {w}_{inf} & {w}_{{d}_{2} {d}_{4}} \\ {w}_{{d}_{3} {d}_{1}} & {w}_{inf} & 0 & {w}_{{d}_{3} {d}_{4}} \\ {w}_{inf} & {w}_{{d}_{4} {d}_{2}} & {w}_{{d}_{4} {d}_{3}} & 0\end{matrix}\right]$$
where w_{didj} represents a distance between road nodes dᵢ and dⱼ; and if there is no direct connection path between the two nodes, wd_{idj} is inf:
step S12: constructing a road network distribution network model, and adding charging loads of various charging stations and daily basic loads of nodes to obtain comprehensive loads of the nodes in the distribution network, with an expression as follows:
$${P}_{a l l}^{i} \left(t\right) = {P}_{b}^{i} \left(t\right) + {P}_{c}^{i} \left(t\right) i = 1 , 2 , 3 , ⋯ , {n}_{G}$$
where
$${P}_{b}^{i} \left(t\right) , {P}_{c}^{i} \left(t\right) \text{and} {P}_{a l l}^{i} \left(t\right)$$
represent a basic load of a power supply node i in the distribution network at a moment t, a fast charging load of an electric vehicle cluster connected to charging stations and a comprehensive load calculated under the node i after the addition, respectively, and n_{G} is a number of distribution network nodes; and
step S13: constructing the fast charging load prediction model based on the trip chain and the Monte Carlo method, and depicting fast charging demand decision the spatial-temporal trajectory change of the user trip to obtain a 24-hour total charging load of a target region and a charging load of each charging station, with an expression as follows:
$${P}_{c}^{a l l} \left(t\right) = {\sum }_{i = 1}^{{N}_{c t}} {P}_{i , c} \left(t\right)$$
$${P}_{i , c} \left(t\right) = {\sum }_{m = 1}^{{N}_{e v}^{i}} {\sum }_{t = 1}^{{t}_{c}} {P}_{f a s t} {μ}_{m}^{i} \left(t\right)$$
where
$${P}_{c}^{a l l} \left(t\right)$$
is a total charging load of the target region P_{i,c}(t) is a charging load of a charging station i, and N_{ct} is a number of charging stations in the target region;
$${N}_{e v}^{i}$$
is a number of electric vehicles connected to the charging station i,
$${μ}_{m}^{i} \left(t\right)$$
is a charging mark of a vehicle m at the moment t, and P_{fast} is fast charging power of an electric vehicle; and t_{c} is charging duration, in minutes.

Preferably, a set of user’s candidate charging stations corresponding to the fast charging demand decision in step S13 is:

$$B = \left\{{S}_{1} , {S}_{2} , ⋯ \left|S O {C}_{n o d e - s}^{m}\right) > S O {C}_{sec} , {T}_{i} < {T}_{L}\right\}$$

where

$$S O {C}_{n o d e - s}^{m}$$

is a battery state of charge (SOC) when a user arrives at an optionalcharging station from a place where a charging demand is generated, and SOC_{sec} is an electrical quantity constraint; Tᵢ = t_{goto} + t_{c} + t_{back} is a total time consumed, where t_{goto}, t_{c} and t_{back} are a time consumed for the user to go to a charging station, a time for charging, and a time for driving to a destination after charging, respectively; and T_{L} is a latest arrival time acceptable by the user.

Preferably, the depicting fast charging demand decision and the spatial-temporal trajectory change of the user trip and in step S13 includes: traversing through trips of the electric vehicle in the target region based on the trip chain to calculate power consumption for each trip and the battery SOC, and determine whether charging is needed; if charging is not needed, proceeding to a next trip until all trip purposes are completed; if charging is needed, calculating a time when a fast charging demand of the electric vehicle is generated and a location where the fast charging demand is generated; planning a path to a nearest charging station by using Dijkstra algorithm, and updating a fast charging load of each charging station in the target region after charging.

Preferably, the trip chain is represented as a whole trip process of a traveler’s trip from a starting point, through several destinations, and then back to the starting point, and includes a spatial feature chain, a temporal feature chain, and a charging feature chain;
in the spatial feature chain,
$${d}_{k}^{m} \left({x}_{i} , {y}_{i}\right)$$
represents a geographical position of the vehicle m at a destination k and is denoted by two-dimensional rectangular coordinates;
$${L}_{{d}_{k} {d}_{k + 1}}^{m} \left(k = 0 , 1 , 2 , ⋯ {n}_{d}\right)$$
is a mileage of the vehicle m from
$${d}_{k}^{m} \text{to} {d}_{k + 1}^{m} ,$$
and n_{d} is a number of destinations comprised in the user’s trip in one day;
in the temporal feature chain,
$$t {s}_{{d}_{k}}^{m}$$
is a moment when the vehicle m leaves a stay point
$${d}_{k}^{m} , t {a}_{{d}_{k}}^{m} , t {r}_{{d}_{k}}^{m}$$
are a time when the vehicle m arrives at the stay point
$${d}_{k}^{m}$$
and a time when the vehicle is parked at the stay point, and
$${t}_{{d}_{k} , {d}_{k + 1}}^{m}$$
is a total time spent for the vehicle m from the starting point
$${d}_{k}^{m}$$
to the destination
$${d}_{k + 1}^{m} ;$$
and in the charging feature chain,
$$S O {C}_{{d}_{k}}^{m}$$
is a battery SOC when the vehicle arrives at the destination
$${d}_{k}^{m} ,$$
and
$$Δ S O {C}_{k , k + 1}^{m}$$
is a total battery SOC variation of the vehicle traveling from the destination
$${d}_{k}^{m}$$
to the destination
$${d}_{k + 1}^{m} ,$$
with a value being an algebraic sum of electrical quantity replenished from a charging station and electrical quantity consumed during the trip.

Preferably, an expression of the weighted user charging location decision model in step S2 is:

$${X}_{W s} = min \left\{{ω}_{c} {C}_{i} + {ω}_{T} {T}_{i} + {ω}_{s o c} {C}_{S O {C}_{i}}\right\}$$

where ^{C}ᵢ, ^{C}_{Ti} and ^{C}_{SOCi} are a user charging cost, a time cost consumed by the user in selecting the charging station i, and a battery SOC cost consumed during the user’s trip under a same dimension, ω_{c,} ω_{T} and ω_{soc} are weight coefficients corresponding to the three costs, respectively; and the user charging cost Cᵢ includes an electricity price cost and a charging service fee cost.

Preferably, quantitative expressions of the user charging cost ^{C}ᵢ, the total user time cost ^{C}_{Ti} and the battery SOC cost ^{C}_{SOCi} are:

$${C}_{i} = {ρ}_{i}^{t} {E}_{h} Δ E$$

$${C}_{{T}_{i}} = {θ}_{L} {T}_{i} = {k}_{t} {S}_{p} / {T}_{p} ⋅ {T}_{i}$$

$${C}_{S O {C}_{i}} = Δ S O {C}_{i} ⋅ {ρ}_{s l o w} ⋅ {E}_{h}$$

where

$${ρ}_{i}^{t}$$

is a charging service fee of the charging station i at the moment t, and ΔE is electrical quantity replenished for a single electric vehicle each time, and Eₕ is a quantitative value of an electrical quantity of the electric vehicle; θ_{L} is a unit trip time value corresponding to a leisure time, with a unit of yuan/h, kₜ is a time value coefficient, Sₚ is an annual income of a worker, and Tₚ is annual working hours of the worker; ΔSOCᵢ is electrical quantity consumed during the user’s trip to charging, and ρ_{slow} is a charging price in a slow charging mode.

Preferably, step S3 includes the following substeps:
step S31: superposing a fast charging load obtained by using the fast charging load prediction model for electric vehicles and a basic load of a target distribution network to obtain a comprehensive load of each node of the distribution network, and constructing a graded charging service fee model for charging stations;
step S32: reducing the comprehensive load to corresponding power supply nodes of the distribution network, and calculating a voltage of each node of the distribution network by using a time sequence load flow; and
step S33: optimizing and adjusting the charging service fee based on an adjustment mechanism with the minimum sum of absolute values of voltage deviations of the nodes in the distribution network in the region as the optimization objective.

Preferably, the graded charging service fee model for charging stations in step S31 is:

$$ρ = \left\{\begin{matrix}{ρ}_{1} & {P}_{m i n} \leq P \leq {P}_{1} \\ {ρ}_{2} & {P}_{1} \leq P \leq {P}_{2} \\ {ρ}_{3} & {P}_{2} \leq P \leq {P}_{3} \\ {ρ}_{4} & {P}_{3} \leq P \leq {P}_{max}\end{matrix}\right)$$

where ρ is a charging service fee; p1, p2, p3 and p4 are four levels of charging service fees, meeting ρₘᵢₙ ≤ ρ1<ρ2<ρ3<ρ4 ≤ ρₘₐₓ, where ρₘᵢₙ is a lower limit of the charging service fee, and ρₘₐₓ is an upper limit of the charging service fee; P is a daily comprehensive load of power supply nodes for 24 hours; and Pₘᵢₙ and Pₘₐₓ are a minimum load and a maximum load in one day; and

a charging service fee grading boundary expression is:

$${P}_{i + 1} = {P}_{i} + Δ P$$

$$Δ P = \frac{{P}_{max} - {P}_{min}}{{n}_{p}}$$

where ΔP is a difference between upper and lower boundaries of adjacent charging service fees, and nₚ is a number of levels of charging service fees, and is set to 4.

Preferably, the adjustment mechanism in step S33 is:

$$Δ {M}_{n , t}^{i} = \left\{\begin{matrix}- \left[\left|Δ {V}_{i , t}\right| / Δ {V}_{b}\right] Δ ρ & \left|Δ {V}_{i , t}\right| < 7 \% \\ 0 & \left|Δ {V}_{i , t}\right| = 7 \% \\ + \left[\left|Δ {V}_{i , t}\right| / Δ {V}_{b}\right] Δ ρ & \left|Δ {V}_{i , t}\right| > 7 \%\end{matrix}\right)$$

$${M}_{n , t}^{\left(i + 1\right)} = {M}_{n , t}^{i} - Δ {M}_{n , t}^{i}$$

where

$$Δ {M}_{n , t}^{i}$$

is a charging service fee adjustment quantity of a charging station n at the moment t during the i th adjustment;

$${M}_{n , t}^{\left(i + 1\right)} \text{and} {M}_{n , t}^{i}$$

are charging service fees of the charging station n at the time t after the i th and (i -1 )^{th} adjustment respectively; ΔV_{b} is defined as a unit voltage deviation, and Δρ is an adjustment stride of a unit deviation charging service fee; ΔV_{i,t} is a voltage per-unit value deviation of a node ⁱ in the distribution network at the moment t, with an expression

$$\text{Δ} {V}_{i , t} = \frac{{V}_{i , t} - {V}_{b}}{{V}_{b}} ,$$

where V_{i,t} is a node voltage per-unit value of the node i at the moment t, and V_{b} os reference voltage per-unit value of each node; and [x] means rounding x.

Compared with the prior art, the present disclosure has the following advantages:

1) The charging guidance method for fast charging loads based on adjustable charging service fees according to the present disclosure can effectively guide users to charge reasonably, reduce charging costs of the users, and improve voltage quality of the distribution network, which has a favorable impact on a distribution network, the electric vehicle users, and charging station operators.

2) In a constructed fast charging load prediction model based on a trip chain and a Monte Carlo method according to the present disclosure, the Monte Carlo method is used to depict spatial-temporal trajectory changes of user trips of urban electric private vehicles and fast charging demand decision in the perspective of the trip chain, to scientifically and accurately predict spatial and temporal distribution of fast charging loads in a region.

3) A weighted user charging location decision model taking three costs, i.e., a charging service fee, travel time, and travel power consumption, into account in the present disclosure is used to make charging location decision from comprehensive benefits of fast charging users, thus improving enthusiasm of users in responding to the strategy.

4) In the present disclosure, a minimum sum of absolute values of voltage deviations of nodes in the distribution network in the region is taken as an optimization objective of a regional graded charging service fee adjustment model, which is of great significance for improving overall voltage quality of the distribution network and balancing regional power supply.

### BRIEF DESCRIPTION OF THE DRAWINGS

FIG. 1 is a general framework diagram of the present disclosure;

FIG. 2 is a schematic structural diagram of a trip chain;

FIG. 3 is a flowchart of Monte Carlo simulation calculation;

FIG. 4 is a structural diagram of a charging service fee of a charging station;

FIG. 5 is a flowchart of charging location decision by fast charging users and charging loads optimal distribution guided by regional charging service fee;

FIG. 6 is a road network - distribution network system diagram;

FIG. 7 shows spatial and temporal distribution of fast charging loads of various charging stations under a fixed charging service fee and a regional graded charging service fee;

FIG. 8 shows charging demand generation locations of various users with fast charging demand in a target region;

FIG. 9 shows spatial and temporal distribution of regional total fast charging loads under a fixed charging service fee and a regional graded charging service fee;

FIG. 10A and FIG. 10B show voltage distribution of distribution network nodes where fast charging loads are connected;

FIG. 11 shows charging service fees of various charging stations; and

FIG. 12 shows change of charging stations before and after 24-hour connection to electric vehicles (EVs).

### DETAILED DESCRIPTION OF THE EMBODIMENTS

The technical solutions in embodiments of the present disclosure will be described clearly and completely below in combination with drawings in the embodiments of the present disclosure. Apparently, the described embodiments are merely some rather than all of the embodiments of the present disclosure. All other embodiments obtained by those in the art based on the embodiments of the present disclosure without creative efforts shall fall within protection scope of the present disclosure.

### Embodiment

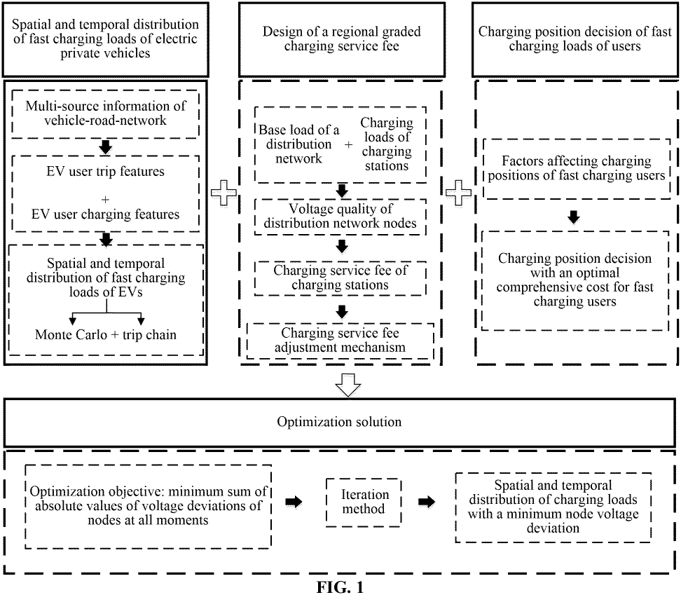

As shown in FIG. 1, the embodiment provides a method for charging guidance of fast charging loads based on an adjustable and graded charging service fee, including the following steps.

### 1. Fast Charging Load Prediction Model for Electric Vehicles Based on Constraints Of Regional Road Network and Distribution Network.

### 1.1. Regional Traffic Road Network Model

Trip characteristics of users of electric vehicle are often constrained by the regional traffic road network. When charging loads are predicted, it is required to consider the influence of the traffic road network on the charging loads and establish a regional traffic road network model. The regional road network structure may be expressed as R=(D,L), where D represents a set of road network nodes (road intersections or starting and ending points), numbered as 1, 2, 3, ..., n; L represents a set of road sections included in a road network R, and an expression of road resistance of each road section in the road network, that is, a distance ^{l}_{didj}, s:

$${l}_{{d}_{i} {d}_{j}} = {l}_{{d}_{j} {d}_{i}} = \left\{\begin{matrix}{w}_{{d}_{i} {d}_{j}} & {d}_{i} \neq {d}_{j} , \left({d}_{i} , {d}_{j}\right) ∈ D \\ 0 & {d}_{i} = {d}_{j} , \left({d}_{i} , {d}_{j}\right) ∈ D \\ {w}_{\text{inf}} & {d}_{i} \neq {d}_{j} , \left({d}_{i} , {d}_{j}\right) ∉ D\end{matrix}\right) . \qquad \text{(1)}$$

It is assumed that all roads in the traffic road network in this region are two-way traffic lanes, an association state of nodes in the road network and a magnitude of road resistance of road sections may be represented by W, and W is an adjacency matrix of road network weights, with an expression as follows:

$$W = \left[\begin{matrix}0 & {w}_{{d}_{1} {d}_{2}} & {w}_{{d}_{1} {d}_{3}} & {w}_{\text{inf}} \\ {w}_{{d}_{2} {d}_{1}} & 0 & {w}_{\text{inf}} & {w}_{{d}_{2} {d}_{4}} \\ {w}_{{d}_{3} {d}_{1}} & {w}_{\text{inf}} & 0 & {w}_{{d}_{3} {d}_{4}} \\ {w}_{\text{inf}} & {w}_{{d}_{4} {d}_{2}} & {w}_{{d}_{4} {d}_{3}} & 0\end{matrix}\right] , \qquad \text{(2)}$$

where ^{w}_{didj} represents a distance between road nodes dᵢ,dⱼ. If there is no direct connection path between two nodes, ^{w}_{didj} is inf, and if there is not path between on the same road, ^{w}_{didj} =0. Geographical positions of the road nodes dᵢ and dⱼ in the region may be expressed as (xᵢ, yᵢ) and (xⱼ, yⱼ), and an expression of path distance between the two nodes is:

$${w}_{{d}_{i} {d}_{j}} = \sqrt{{\left({x}_{i} - {x}_{j}\right)}^{2} + {\left({y}_{i} - {Y}_{J}\right)}^{2}} . \qquad \text{(3)}$$

### 1.2. Road Network - Distribution Network Model

It is assumed that the nodes of the regional distribution network supply power to basic loads in a power supply zone and fast charging loads of electric vehicles at fast charging stations included. When a comprehensive load of each node in the distribution network is counted, a charging load of each charging station is calculated under a corresponding power supply node of the distribution network, and added with a daily basic load of the node to obtain an overall comprehensive load of the distribution network, with an expression as follows:

$${P}_{a l l}^{i} \left(t\right) = {P}_{b}^{i} \left(t\right) + {P}_{c}^{i} \left(t\right) i = 1 , 2 , 3 , ⋯ , {n}_{G} , \qquad \text{(4)}$$

where

$${P}_{b}^{i} \left(t\right) , {P}_{c}^{i} \left(t\right) \text{and} {P}_{a l l}^{i} \left(t\right)$$

represent a basic load of a power supply node i in the distribution network at a moment t, a fast charging load of an electric vehicle cluster connected to charging stations and a comprehensive load calculated under the node i after addition, respectively, and n_{G} is a number of distrubtion netowork nodes.

### 1.3. Fast Charging Load Prediction Model Based on a Trip Chain and Monte Carlo Simulation

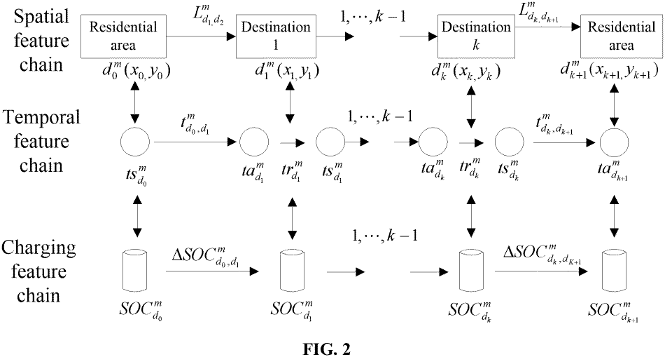

The trip chain is an important means to depict each user’s trip pattern, and describes a whole trip process of the traveler’s trip from a starting point, through several destinations, and then back to the starting point. The trip chain really reveals continuity characteristics of the whole process of the urban traffic trip and reflects the continuous dynamics of the user’s traffic trip. A schematic structural diagram of an electric vehicle trip chain of the present disclosure is shown in FIG. 2, and the trip chain includes a spatial feature chain, a temporal feature chain, and a charging feature chain.

In the spatial feature chain,

$${d}_{k}^{m} \left({x}_{i} , {y}_{i}\right)$$

represents a geographical position of a vehicle m at a destination k and is denoted by two-dimensional rectangular coordinates;

$${L}_{{d}_{k} {d}_{k + 1}}^{m} \left(k = 0 , 1 , 2 , ⋯ {n}_{d}\right)$$

is a mileage of the vehicle m from

$${d}_{k}^{m} \text{to} {d}_{k + 1}^{m} ,$$

and n_{d} is a number of destinations included in the user’s trip in one day. It is assumed that the starting point and ending point of the user’s daily trip are residential areas, and from which a user drives to various destinations for daily work, entertainment and other activities. In the temporal feature chain,

$$t {s}_{{d}_{k}}^{m}$$

is a moment when the vehicle m leaves a stay point

$${d}_{k}^{m} , t {a}_{{d}_{k}}^{m} , t {r}_{{d}_{k}}^{m}$$

are a time when the vehicle m arrives at the stay point

$${d}_{k}^{m}$$

and a time when the vehicle is parked at the stay point respectively, and

$${t}_{{d}_{k} , {d}_{k + 1}}^{m}$$

is a total time taken for the vehicle m from the starting point

$${d}_{k}^{m}$$

to the destination

$${d}_{k + 1}^{m} .$$

In the charging feature chain,

$$S O {C}_{{d}_{k}}^{m}$$

is a state of charge (SOC) of a battery when the vehicle arrives at the destination

$${d}_{k}^{m} {}_{, \text{and}} Δ S O {C}_{k , k + 1}^{m}$$

is a total battery SOC variation of the vehicle traveling from the destination

$${d}_{k}^{m} {}_{\text{to the destination}} {d}_{k + 1}^{m} ,$$

with a value being an algebraic sum of electrical quanity replenished at a charging station and electrical quantity consumed during the trip.

Expressions for calculating 24-hour total charging load [symbol] of the target region and the charging load P_{i,c}(t) of each charging station are expressed in minutes, as follows:

$${P}_{c}^{a l l} \left(t\right) = {\sum }_{i = 1}^{{N}_{c t}} {P}_{i , c} \left(t\right) , \qquad \text{(5)}$$

$${P}_{i , c} \left(t\right) = {\sum }_{m = 1}^{{N}_{e v}^{i}} {\sum }_{t = 1}^{{t}_{c}} {P}_{f a s t} {μ}_{m}^{i} \left(t\right) , \qquad \text{(6)}$$

where N_{ct} is a number of charging stations in the target region;

$${N}_{e v}^{i}$$

is a number of electric vehicles connected to the charging station i, and

$${μ}_{m}^{i} \left(t\right)$$

is a charging mark of the vehicle m at the moment t.

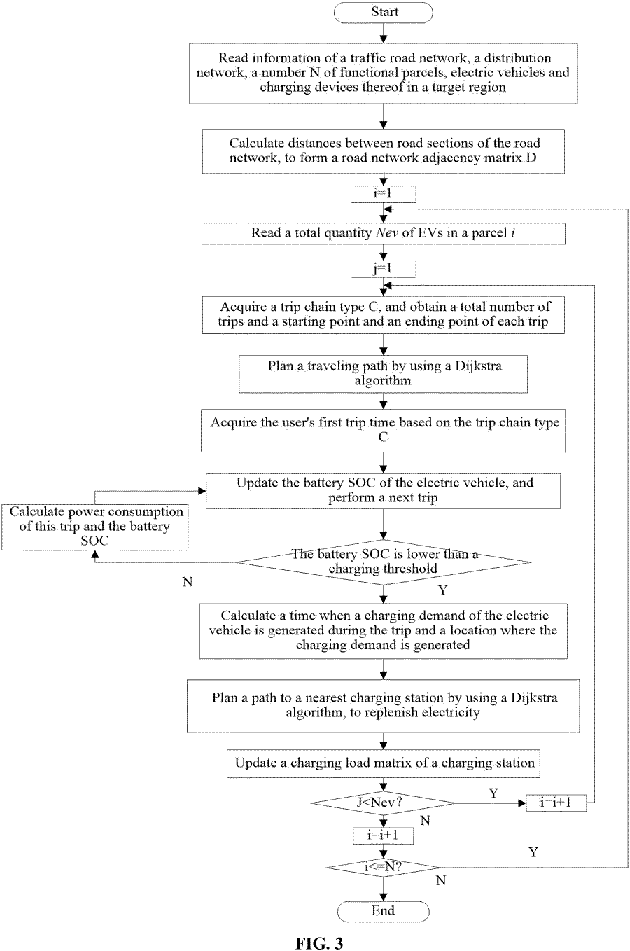

The fast charging load prediction model for electric private vehicles based on a trip chain and Monte Carlo simulation is shown in FIG. 3.

### 2. Regional Graded Charging Service Fee Model Based on a Comprehensive Load and Voltage Quality of the Distribution Network

In view of the commercial operation requirements on electric vehicles, different charging stations may require different charging service fees (including charging prices). The present disclosure provides a charging service fee adjustment mechanism and a regional graded charging service fee model based on a comprehensive load (including a basic load and a charging load) and voltage quality of the distribution network, specifically as follows.

A fast charging load obtained from the fast charging load prediction model for electric vehicles is added with a basic load of a target distribution network, and a comprehensive load obtained after the addition is used to obtain an initial graded charging service fee model for charging stations.

The comprehensive load is calculated under corresponding power supply node of the distribution network, and a voltage of each node of the distribution network is calculated by using a sequential power flow

With a minimum sum of absolute values of voltage deviations of distribution network nodes in the region as an optimization objective, a price mechanism is used to guide fast charging users to make charging location decision and replenish electricity, so as to improve voltage quality of the distribution network and reduce charging costs of electric vehicle users.

### 2.1. Graded Charging Service Fee Model for a Charging Station Based on Integration of a Basic Load and a Charging Load

In a region, by default, a charging service fee of a charging station may be composed of four price levels shown in formula (7). ρ is a charging service fee; ρ₁, ρ₂, ρ₃ and ρ₄ are four levels of charging service fees; P is a daily comprehensive load of power supply nodes for 24 hours; and Pₘᵢₙ and Pₘₐₓ are a minimum load and a maximum load in one day.

$$ρ = \left\{\begin{matrix}{ρ}_{1} {P}_{min} \leq P \leq {P}_{1} \\ {ρ}_{2} {P}_{1} \leq P \leq {P}_{2} \\ {ρ}_{3} {P}_{2} \leq P \leq {P}_{3} \\ {ρ}_{4} {P}_{3} \leq P \leq {P}_{max}\end{matrix}\right) . \qquad \text{(7)}$$

The charging service fee in the present disclosure includes a price of electricity purchased by electric vehicle operators from a power grid, and the charging service fee must be limited within a certain range to give consideration to interests of electric vehicle users and operators. ρₘᵢₙ is a lower limit of the charging service fee, and should be higher than a cost of purchasing electricity from the power grid, to ensure the operators’ incomes. ρₘₐₓ is an upper limit of the charging service fee. To protect the interests of users and increase a penetration rate of electric vehicles, the upper limit of the charging service fee should be lower than a calculated oil price. The constraint on charging service fee of charging stations at all levels may be expressed as formula (8):

$${ρ}_{min} \leq {ρ}_{1} < {ρ}_{2} < {ρ}_{3} < {ρ}_{4} \leq {ρ}_{max} . \qquad \text{(8)}$$

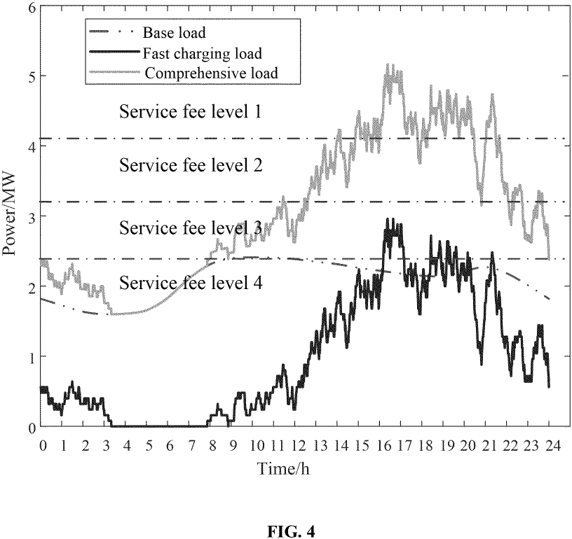

A relationship between the charging service fee and the comprehensive load may be expressed as formula (9):

$${P}_{i + 1} = {P}_{i} + Δ P , \qquad \text{(9)}$$

$$Δ P = \frac{{P}_{max} - {P}_{min}}{{n}_{p}} , \qquad \text{(10)}$$

whereΔP is a difference between upper and lower boundaries of adjacent charging service fees, and to some extent, ΔP may be simplified to formula (10); nₚ is a number of levels of charging service fees, and the value herein is 4. A hierarchical structural diagram of a 24-hour charging service fee of a charging station is shown in FIG. 4.

### 2.2. Charging Service Fee Adjustment Mechanism Based on a Node Voltage of the Distribution Network

In the present disclosure, by analyzing the influence of the connection of large-scale fast charging loads of electric vehicles on the voltage quality of the distribution network, the charging service fee of each charging station is adjusted. The connection of large-scale and high-power disorderly fast charging loads is bound to cause nonuniform spatial and temporal distribution of charging loads, resulting in serious accumulation of charging loads in individual charging stations at a moment, which seriously endangers the voltage quality of power supply nodes in the distribution network. After the fast charging load and the basic load are connected to the distribution network, the node voltage level of the distribution network is analyzed through power flow calculation, and the charging service fee of each charging station is adjusted according to the adjustment strategy shown in formulas (26) and (27) to guide electric vehicle users to charge reasonably, so as to balance spatial and temporal distribution of the fast charging loads and improve the voltage level of the distribution network.

An expression of voltage per-unit value deviation of the distribution network node i at the moment t is:

$$Δ {V}_{i , t} = \frac{{V}_{i , t} - {V}_{b}}{{V}_{b}} , \qquad \text{(11)}$$

where V_{i,t} is a node voltage per-unit value of the node i at the moment t, and V_{b} is a reference voltage per-unit value of each node, and is set to 1 in this embodiment.

The adjustment of the charging service fee is determined by determining whether the node voltage deviation of a fast charging load connection point meets constraints of a distribution network structure. An expression of voltage deviation ΔVᵢₜ of each node is:

$$Δ {V}_{i t} = \frac{{V}_{i t} - {V}_{i 0}}{{V}_{i 0}} , \qquad \text{(12)}$$

The specific charging service fee adjustment strategy of each fast charging station may be described by formula (13) and formula (14).

$$Δ {M}_{n , t}^{i}$$

is a charging service fee adjustment quantity of a charging station n at the moment t during the ith adjustment.

$${M}_{n , t}^{\left(i + 1\right)} {}_{\text{and}} {M}_{n , t}^{i}$$

are charging service fees of the charging station n at the time t after i th and (i-1)^{th} adjustment respectively. ΔV_{b} is defined as a unit voltage deviation, with a value of 0.01, Δρ is an adjustment stride of a unit deviation charging service fee, with a value of 0.01 yuan. [x] means rounding x.

$$Δ {M}_{n , t}^{i} = \left\{\begin{matrix}- \left[\left|Δ {V}_{i , t}\right| / Δ {V}_{b}\right] Δ ρ & \left|Δ {V}_{i , t}\right| < 7 \% \\ 0 & \left|Δ {V}_{i , t}\right| = 7 \% \\ + \left[\left|Δ {V}_{i , t}\right| / Δ {V}_{b}\right] Δ ρ & \left|Δ {V}_{i , t}\right| > 7 \%\end{matrix}\right) , \qquad \text{(13)}$$

$${M}_{n , t}^{\left(i + 1\right)} = {M}_{n , t}^{i} - Δ {M}_{n , t}^{i} . \qquad \text{(14)}$$

### 3. Research on Charging Location Decision Based on a Minimum Comprehensive Cost of the Fast Charging User

### 3.1. Set B of User’s Candidate Charging Stations

It is assumed that the battery SOC

$$S O {C}_{n o d e - s}^{m}$$

when a user arrives at an optional charging station from a place where a charging demand is generated should be greater than 10%, and thus an electrical quantity constraint may be expressed as formula (15):

$$S O {C}_{n o d e - s}^{m} \geq S O {C}_{sec} = 10 \% , \qquad \text{(15)}$$

A total time Tᵢ taken by a fast charging user in the process of generating a charging demand, driving to a charging station, replenishing electricity and reaching a destination is lower than a latest arrival time constraint T_{L} acceptable by the user, and may be expressed as formula (16):

$${t}_{g o t o} + {t}_{c} + {t}_{b a c k} = {T}_{i} < {T}_{L} , \qquad \text{(16)}$$

where t_{goto}, t_{c} and t_{back} are a time taken for the user to go to a charging station, a time for charging, and a time for driving to a destination after charging, respectively. Under the above constraint, the set B of user’s candidate charging stations can be expressed as formula (17):

$$B = \left\{{S}_{1} , {S}_{2} , ⋯ \left|S O {C}_{n o d e - s}^{m} < S O {C}_{sec} , {T}_{i} < {T}_{L}\right)\right\} , \qquad \text{(17)}$$

### 3.2. User Charging Decision Model X_{Ws}

When the user makes charging decision, the user often comprehensively consider factors such as time, a charging service fee cost, a battery SOC, etc., and selects a charging station with a minimum comprehensive charging cost and goes to this charging station for charging. Therefore, the present disclosure provides a charging location decision method based on a minimum comprehensive charging cost of fast charging user, and the influence of a charging service fee, a total time taken and a battery SOC on the user’s charging station location selection is described by using a weighted decision model. The decision model may be expressed as a model (18):

$${X}_{W s} = min \left\{{ω}_{c} {C}_{i} + {ω}_{T} {C}_{T i} + {ω}_{s o c} {C}_{S O {C}_{i}} \left|i = 1 , ⋯ , n\right)\right\} , \qquad \text{(18)}$$

where ^{C}ᵢ is a user charging cost, including an electricity price cost and a service fee cost; ^{C}_{Ti} is a total time cost of the user; ^{C}_{SOCi} is a battery SOC cost consumed during the user’s trip; and ω_{c}, ω_{T} and ω_{soc} are weight coefficients of the three costs, respectively.

A time value coefficient is ^{C}_{Ti}.

In view of the problem that a time cost, a charging cost and a battery power cost cannot be directly weighted due to different dimensions, in the present disclosure, it is considered to convert the battery power cost and the time cost into costs with the same dimension as a charging cost. An income method is used to quantify the user’s time cost, and the time value coefficient (a certain percentage of a personal income under the current market economy construction) is used to quantify the time cost. A specific calculation method may be expressed as formula (19):

$${θ}_{L} = {k}_{t} {S}_{p} / {T}_{p} , \qquad \text{(19)}$$

where θ_{L} is a unit trip time value corresponding to a leisure time, with a unit of yuan/h; kₜ is a time value coefficient, and its value is suggested to be 50% in view of the imperfect market economy construction and wage distribution system in China; Sₚ is an annual income of a worker, its value is set to per capital annual income in Shanghai, 87222 yuan; and Tₚ is annual working hours of the worker, which is set to 365*8 h. Therefore, a time cost consumed by the user in selecting the charging station i may be quantified as formula (20):

$${C}_{{T}_{i}} = {θ}_{L} {T}_{i} = {k}_{t} S p / T p ⋅ {T}_{i} , \qquad \text{(20)}$$

The battery SOC cost consumed during the charging of the fast charging demand user’s vehicle may be quantified as a cost spent in compensating in a slow charging mode for the same electrical quantity consumed during the charging, with a specific calculation formula (21) as follows:

$$C s o c i = \text{Δ} S O {C}_{i} ⋅ {ρ}_{s l o w} ⋅ {E}_{h} , \qquad \text{(21)}$$

where ΔSOCᵢ is electrical quantity consumed during the charging of the user’s vehicle, and ρ_{slow} is a charging price in a slow charging mode, and is 0.63 yuan/kWh.

The fast charging demand user goes to a charging station for charging, a charging cost Cᵢ may be expressed as formula (22),

$${ρ}_{i}^{t}$$

is a charging service fee of the charging station i at the moment t, and ΔE is electrical quantity replenished each time for a single electric vehicle.

$${C}_{i} = {ρ}_{i}^{t} {E}_{h} \text{ΔΕ} \text{.} \qquad \text{(22)}$$

Therefore, after the time cost, the battery power cost and the charging cost are converted into the same dimension by using formulas (20)-(23), the user charging location decision model may be modified as formula (23):

$$\begin{matrix}{X}_{W s} = min \left\{{ω}_{c} {C}_{i} + {ω}_{T} {T}_{i} + {ω}_{s o c} {C}_{S O {C}_{i}}\right\} \\ = min \left\{{ρ}_{i}^{t} {E}_{h} Δ E + k {}_{t} \frac{{S}_{p}}{{T}_{p}} {T}_{i} + Δ S O {C}_{i} {ρ}_{s l o w} {E}_{h}\right\} .\end{matrix} \qquad \text{(23)}$$

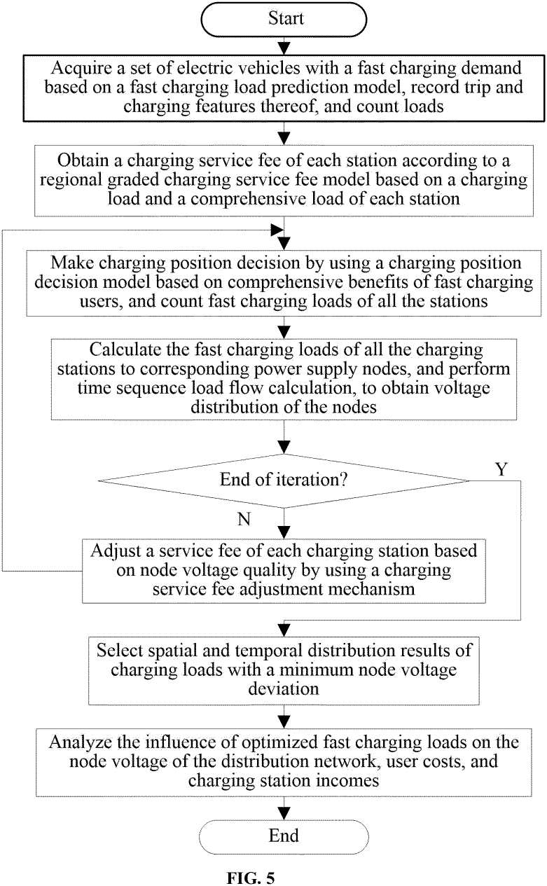

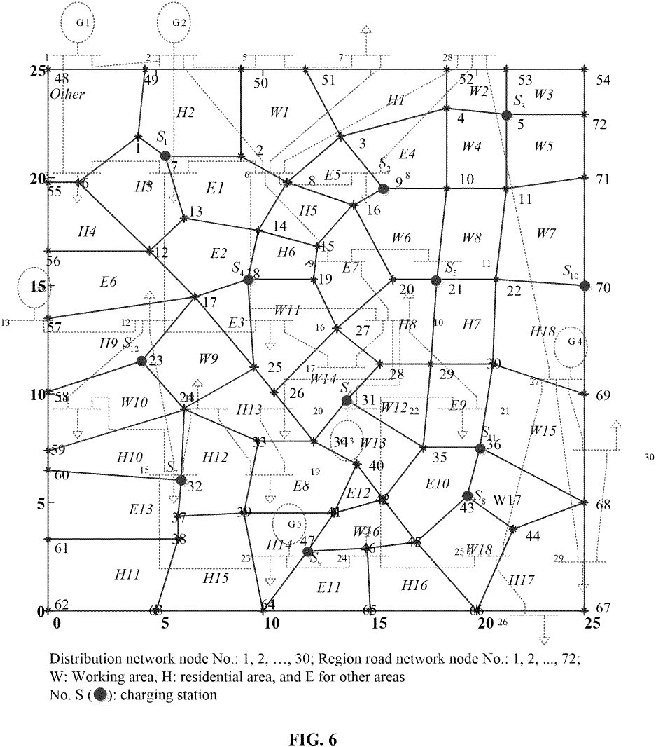

A process of charging loads optimal distribution and charging location decision of fast charging users guided by regional charging service fee is shown in FIG. 5.

### 4. Taking a Typical Region and a Typical IEEE30 Node Distribution Network as Examples, Simulation was Performed to Verify Effectiveness of the Method in the Present Disclosure.

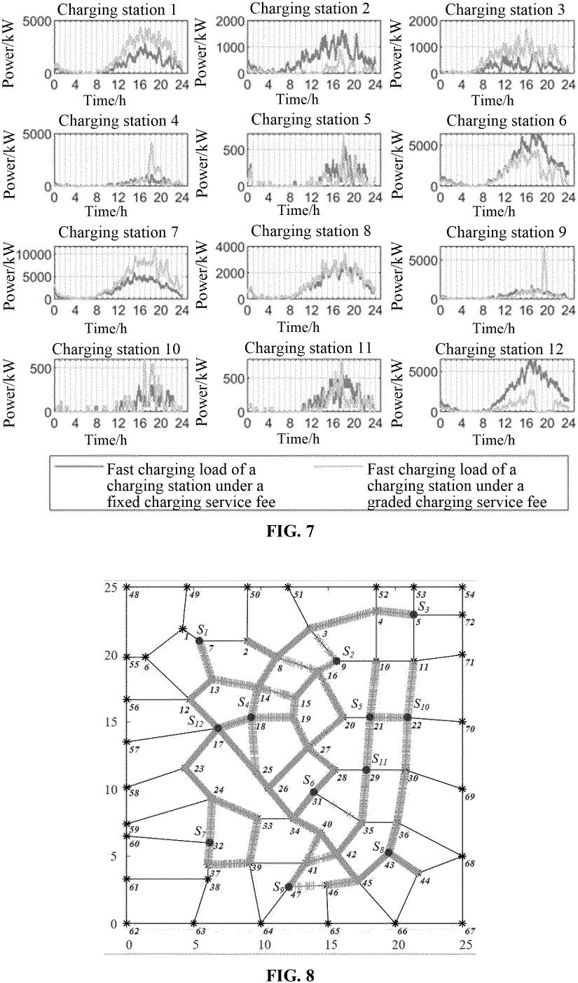

A road network-distribution network system is shown in FIG. 5. The target region is a parcel of 25 km*25 km, which contains 72 road nodes and 144 roads. Bounded by roads, the target region includes 18 residential areas, 18 work areas and 14 other areas. There are 12 fast charging stations in the target region, as shown in FIG. 7, sequentially numbered as S1, S2, ..., S11, and S12, which are powered by nodes No. 3, No. 5, No. 7, No. 8, No. 12, No. 18, No. 21, and No. 24 of a typical IEEE30-node distribution network, respectively, and some nodes are set to supply power to a plurality of fast charging stations. It is assumed that each charging station has enough charging piles to meet the fast charging demand of users under a current penetration rate of electric vehicles in the region. All charging stations are equipped with single fast charging piles with charging power of 60 kW.

According to the Interim Provisions of Shanghai Municipality on the Construction and Management of Electric Vehicle Charging Facilities, the maximum charging service fee shall not exceed 1.6 yuan /kWh, so 1.5/kWh is taken as a fixed charging service fee (including a charging price and a service fee) of each charging station of the present disclosure. In this mode, electric vehicles are charged in a nearest way. When a regional graded charging service fee is used, the electricity price in Shanghai during peak hours of general industry and commerce (0.912 yuan/kWh) is taken as a lower limit of the charging service fee. In an example, an electric vehicle consumes 0.25 kWh of electricity per kilometer, so that an upper limit of the calculated charging service fee ρₘₐₓ may be obtained as 2.8 yuan/kWh. In order to protect the interests of users and charging stations, initial ρ₁ and ρ₄ of each charging station are set to 1.4 yuan/kWh and 1.6 yuan/kWh.

There are 122,900 electric vehicles in the target region, with their daily initial location being in the residential areas. It is assumed that users drive new NissanLeaf electric private vehicles with a battery capacity of 40 kWh, the average speed of users driving electric vehicles is 50 km/h, and the power consumption per mileage is 0.25 kWh/km.

### 1) Comparative Analysis of a Fast Charging Load of Each Charging Station Under a Fixed Charging Service Fee and a Graded Charging Service Fee

According to a spatial and temporal distribution prediction model of fast charging loads, spatial and temporal distribution of regional fast charging loads of each charging station based on a fixed charging service fee under traffic road network constraints is obtained. Based on the regional graded charging service fee model and the user charging location decision model, fast charging users are guided to charge reasonably, and optimized spatial and temporal distribution of fast charging loads is obtained. Under the fixed charging service fee and the graded charging service fee, the spatial and temporal distribution and distribution features of 24-hour fast charging loads in each charging station are shown in FIG. 7 and Table 1.

TABLE 1

| Charging station parameter | | | Under a fixed charging service fee | | | Under a regional graded charging service fee | | |
|---|---|---|---|---|---|---|---|---|
| Charging station | Distribution network node | Charging station location | Peak moment | Peak/kW | Total charging demand/kWh | Peak moment | Peak/kW | Total charging demand/kWh |
| 1 | 3 | 7 | 16:43 | 2520 | 19440 | 6900 | 16:43 | 54900 |
| 2 | 7 | 9 | 16:54 | 7500 | 70170 | 4500 | 16:59 | 38460 |
| 3 | 5 | 5 | 18:07 | 3420 | 32700 | 3780 | 18:08 | 39210 |
| 4 | 8 | 18 | 18:31 | 5460 | 46830 | 2340 | 15:40 | 17010 |
| 5 | 12 | 21 | 15:37 | 2820 | 23400 | 6600 | 17:04 | 45870 |
| 6 | 21 | 31 | 16:32 | 18720 | 168600 | 21900 | 17:32 | 200640 |
| 7 | 21 | 32 | 15:40 | 14100 | 136530 | 19200 | 15:45 | 186510 |
| 8 | 24 | 43 | 16:30 | 12000 | 115200 | 14280 | 16:20 | 141630 |
| 9 | 24 | 47 | 15:13 | 4260 | 39660 | 3660 | 19:01 | 26550 |
| 10 | 12 | 22 | 16:43 | 1860 | 13770 | 2220 | 17:08 | 14370 |
| 11 | 18 | 29 | 17:04 | 10800 | 88800 | 4020 | 15:02 | 20640 |
| 12 | 8 | 17 | 16:24 | 4620 | 40680 | 1860 | 19:32 | 9990 |

As can be seen from FIG. 7 and Table 1, under the fixed charging service fee, the charging load of each fast charging station is generally in single-peak distribution, and the peak moments vary with the locations of the charging stations, with the earliest peak moment appearing at 15:13 and the latest peak moment appearing at 18:31. There are great differences in the peak values of charging loads and the total charging quantity of different charging stations.

From Table 1 and FIG. 8, the location distribution of users’ charging demands under the fixed charging service fee shows that there are many users’ charging demands near charging stations No. 2, No. 6, No. 7, No. 8 and No. 11. When users choose a charging station nearby, the number of vehicles connected to these stations and the fast charging loads are correspondingly large, especially the charging station No. 6, which has the largest number of, i.e., 14,336, charging users within a radius of 4 kilometers, and its random daily fast charging and negative charging quantity of the station is the highest among all stations, reaching 168,600 kWh.

### 2) Comparative Analysis of a Regional Total Fast Charging Load Under a Fixed Charging Service Fee and a Graded Charging Service Fee

Under the fixed charging service fee and the graded charging service fee, spatial and temporal distribution results of a total fast charging load in the target region within 24 hours are shown, and distribution features of the regional total fast charging load are shown in Table 2.

TABLE 2

| Under a fixed charging service fee | | | Under a regional graded charging service fee | | |
|---|---|---|---|---|---|
| Peak moment | Peak/MW | Total charging demand/MWh | Peak moment | Peak/MW | Total charging demand/MWh |
| 16:40 | 79.20 | 795.78 | 16:37 | 79.08 | 795.78 |

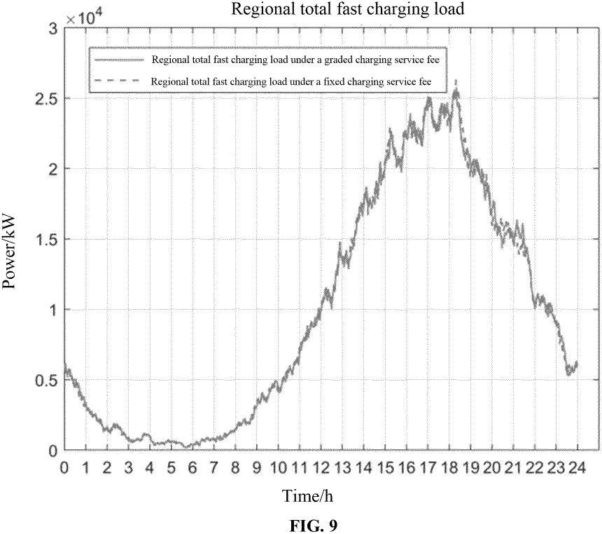

There are 26,528 fast charging demand users in the region, accounting for 21.58% of the total electric vehicle users. As can be seen from FIG. 9, under the fixed charging service fee, the disorderly charging load generated in a manner that the user selects a nearest charging location, is generally in single-peak distribution, with the peak moment of the charging load being at 16:40, the peak of 79.20 MW, and the total charging quantity of 795.78 MWh.

### 3) Influence of the Fast Charging Load on Voltage Quality of the Distribution Network Under the Fixed Charging Service Fee and the Graded Charging Service Fee

Sequential power flow calculation is performed on the fast charging loads connected to the typical distribution network in the target region under different conditions. The 24-hour node voltage change of the distribution network with only the basic load and the regional fast charging load connection under different charging service fee modes is shown, and the voltage deviation of the nodes when the electric vehicle loads are connected to the distribution network in different states is shown in Table 3.

TABLE 3

| Load connection state | Total voltage deviation | Number of nodes with a per-unit value lower than 0.93 | Node No. (moment No.) with the per-unit value lower than 0.93 | | | | |
|---|---|---|---|---|---|---|---|
| Only the basic load | 22.081 | No | | | No | | |
| | | | No. 7 | No. 8 | No. 18 | No. 19 | No. 20 |
| Fast charging load under a fixed charging service fee | 37.804 | 5 | (28,29, 30,31, 32,33, 34,35, 36,37, 38,39,40) | (26,27, 28,29, 30,31, 32,33, 34,35, 36,37, 38,39, 40,41) | (26,27,28, 29,30,31, 32,33,34, 35,36,37, 38,39,40, 41,42,43) | (28,29,30, 31,32,33, 34,35,36, 37,38,39, 40,41,43) | (29,30,31, 32,33,34, 35,36,37) |
| Fast charging load under a regional graded service fee | 33.525 | No | | | No | | |

When only the basic load is connected to the distribution network, the node voltage quality is generally good. However, the node No. 8, the node No. 19, and the node No. 30 are end nodes of the whole distribution network, and the basic load is heavy, so that the voltage quality of the nodes is relatively poor. Their peak load occurs at 10:00 and 21:00, and in this case, the voltage deviation of each node in the whole network is the largest. The node with the lowest voltage in the whole network is the node No. 8, which appears at 10:00, and its voltage per-unit value is 0.960.

### 4) Based on a Fixed Charging Service Fee

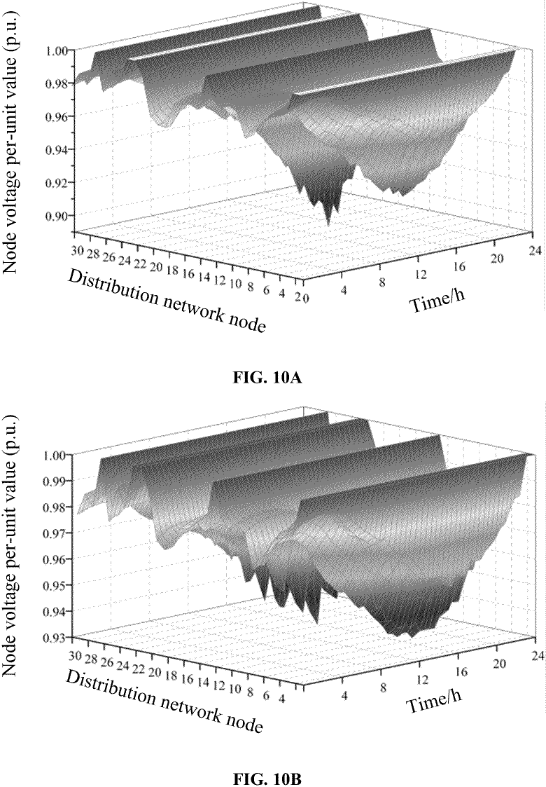

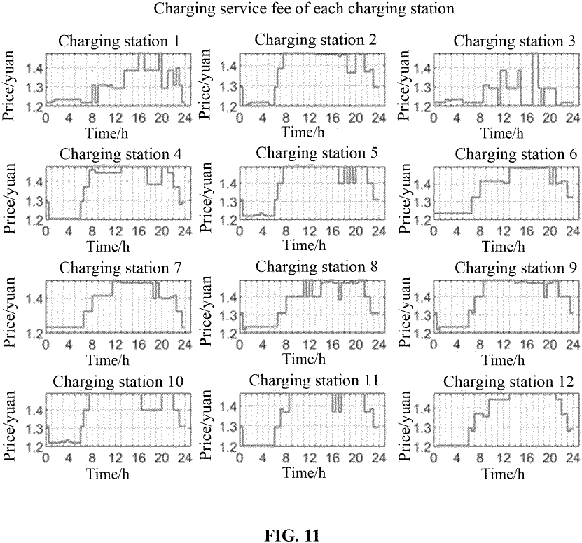

(a) FIG. 10A and FIG. 10B show a node voltage distribution diagram when a random fast charging load caused in the user with a fast charging demand selecting a nearest charging station to replenish electricity under a fixed charging service fee is connected to the distribution network . With the connection of high-power fast charging loads, the voltage quality of the distribution network nodes is further deteriorated. Nodes No. 7, No. 8, No. 18, No. 19 and No. 20 have large voltage deviation, and the voltage of the node No. 18 has the most serious drop, with the node voltage per-unit value reaching 0.883 at 17:30, and the number of moments when the node voltage per-unit value is lower than 0.93 reaches 18 continuously. If no corresponding measures is taken to improve voltage quality, the safety and stability of distribution network operation would be greatly reduced. As can be seen from Table 3, with the connection of random fast charging loads, the total deviation of the node voltage reaches 37.804, which increases by 15.726 under the connection of the basic load.

### 5) Based on a Regional Graded Charging Service Fee

Users are guided to change a charging location by adjusting the charging service fee. The voltage distribution of each node after the actual charging load being connected to the distribution network is shown in FIG. 10B. With the guidance of the charging service fee, the voltage quality of the distribution network in the case of connection of the fast charging load is greatly improved. The voltage per-unit values of all nodes in the whole network are higher than 0.93 at all times, and the overall voltage deviation is 33.525, which decreases by 4.279 under the fixed charging service fee when the fast charging load is connected, so that the effect of voltage quality optimization is obvious.

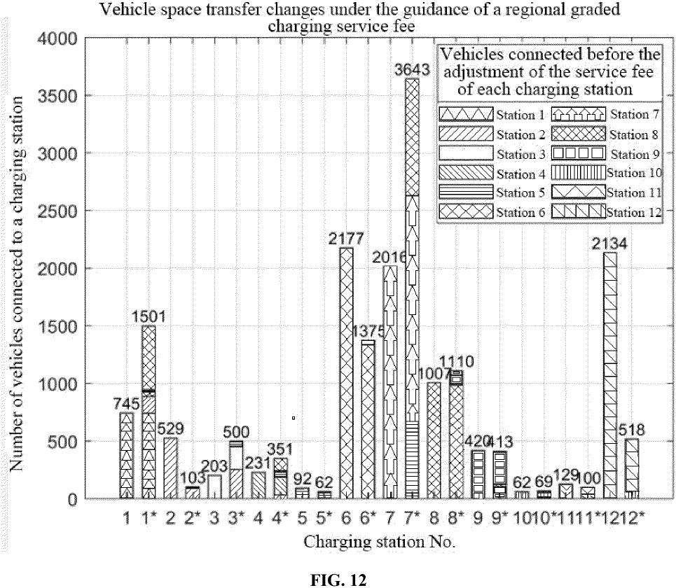

FIG. 11 shows a 24-hour charging service fee of each charging station with a minimum total voltage deviation of the distribution network in the target region. When the fixed charging service fee and the graded charging service fee are applied at each charging station, a change of a total number of electric vehicles connected to each charging station within 24 hours is shown in FIG. 12. For the former, the charging station are numbered as 1, 2, 3, ..., 11, and 12, while for the latter, the charging stations are numbered are 1*, 2*, 3*, ..., 11*, and 12*. It can be seen that after the adjustment strategy of the graded charging service fee is introduced, users selects a charging station with a minimum comprehensive cost for charging by comparing comprehensive charging costs in case of going to different charging stations,, which therefore implements the spatial and temporal transfer of the charging load.

TABLE 4

| Cost | Charging service fee | Time cost/yuan | Battery cost/yuan | Total cost/yuan |
|---|---|---|---|---|
| | cost/yuan | | | |
| Fixed charging service fee | 1193760.00 | 168371.06 | 15472.70 | 1377603.76 |
| Regional graded charging service fee | 1082975.40 | 177092.68 | 15808.47 | 1275876.55 |
| Cost increment | -110784.60 | 8721.62 | 335.77 | -101727.21 |
| Increase percentage/% | -9.28 | 5.18 | 2.17 | -7.38 |

TABLE 5

| Benefit | Profit/yuan | Total revenue/yuan |
|---|---|---|
| Fixed charging service fee | 468008.64 | 1193760.00 |
| Regional graded charging service fee | 357224.04 | 1082975.40 |
| Increase percentage/% | -23.67 | -9.28 |

Table 4 and Table 5 show a comparison between a charging cost of electric vehicle users and a power supply income of charging station operators under the fixed charging service fee and the regional graded charging service fee, respectively. On the one hand, in the perspective of the users’ charging cost, when each charging station applies the fixed charging service fee, the users with a fast charging demand in the target region decides a location of a charging station according to the principle of proximity, and the total charging cost is 1,377,603.76 yuan. When the regional graded charging service fee in the present disclosure is applied, the total cost is 1,275,876.55 yuan. The cost of the user charging service fee based on the regional graded charging service fee is 110,784.6 yuan, which is 9.28%, less than that of the nearest electricity replenishing. However, because a charging station with a lower charging service fee is selected, users have to sacrifice the time cost and drive the vehicle to a distant charging station, which makes the travel time cost of the latter increase compared with that of the former. In the perspective of battery cost, there is no large difference between them. However, in the total cost of the two, the charging cost of the latter is 7.38% lower than that of the former, and the charging benefit of users is obvious.

The above is only specific implementations of the present disclosure, but the protection scope of the present disclosure is not limited thereto. Any person skilled in the art can easily conceive various equivalent modifications or replacements within the technical scope of the present disclosure, and these modifications or replacements shall fall within the protection scope of the present disclosure. Therefore, the protection scope of the present disclosure should be subject to the protection scope of the claims.

What is claimed is:

1. A charging guidance method for fast charging loads based on an adjustable and graded charging service fee, comprising:
step S1: establishing, according to constraints of a regional road network and a distribution network, a fast charging load prediction model based on a trip chain and a Monte Carlo method, to predict a fast charging demand and a spatial-temporal trajectory change of a user trip;
step S2: deciding a charging location based on a weighted user charging location decision model with an objective function being a minimum comprehensive cost of a charging service fee, travel time and travel power consumption, counting a fast charging load of each charging station, calculating the fast charging loads of the charging stations under corresponding power supply nodes to calculate sequential power flow;
step S3: constructing a regional graded charging service fee adjustment model with a minimum sum of absolute values of voltage deviations of the nodes in the distribution network in a region as an optimization objective, and optimizing and adjusting the charging service fee; and
step S4: determining an optimal user charging location under fast charging loads by using the weighted user charging location decision model based on the adjusted charging service fee.

2. The method according to claim 1, wherein step S1 comprises:
step S11: constructing a regional road network model R=(D,L), wherein D represents a set of road network nodes, L represents a set of road sections included in a road network R, and obtaining a road network weight adjacency matrix W comprising association state of nodes in the road network and road resistance of road sections, with an expression as follows:
$$W = \left[\begin{matrix}0 & {w}_{{d}_{1} {d}_{2}} & {w}_{{d}_{1} {d}_{3}} & {w}_{inf} \\ {w}_{{d}_{2} {d}_{1}} & 0 & {w}_{inf} & {w}_{{d}_{2} {d}_{4}} \\ {w}_{{d}_{3} {d}_{1}} & {w}_{inf} & 0 & {w}_{{d}_{3} {d}_{4}} \\ {w}_{inf} & {w}_{{d}_{4} {d}_{2}} & {w}_{{d}_{4} {d}_{3}} & 0\end{matrix}\right]$$
wherein W_{dᵢdⱼ} represents a distance between road nodes dᵢ and dⱼ; and if there is no direct connection path between the two nodes, W_{dᵢdⱼ} is inf;
step S12: constructing a road network distribution network model, and adding charging loads of various charging stations and daily basic loads of nodes to obtain comprehensive loads of the nodes in the distribution network, with an expression as follows:
$${P}_{a l l}^{i} \left(t\right) = {P}_{b}^{i} \left(t\right) + {P}_{c}^{i} \left(t\right) i = 1 , 2 , 3 , ⋯ , {n}_{G}$$
wherein
$${P}_{b}^{i} \left(t\right) , {P}_{c}^{i} \left(t\right)$$
and
$${P}_{a l l}^{i} \left(t\right)$$
represent a basic load of a power supply node i in the distribution network at a moment t, a fast charging load of an electric vehicle cluster connected to charging stations and a comprehensive load calculated under the node
ⁱ after the addition, respectively, and n_{G} is a number of distribution network nodes; and
step S13: constructing the fast charging load prediction model based on the trip chain and the Monte Carlo method, and depicting fast charging demand decision and the spatial-temporal trajectory change of the user trip to obtain a 24-hour total charging load of a target region and a charging load of each charging station, with an expression as follows:
$${P}_{c}^{a l l} \left(t\right) = {\sum }_{i = 1}^{{N}_{c t}} {P}_{i , c} \left(t\right)$$
$${P}_{i , c} \left(t\right) = {\sum }_{m = 1}^{{N}_{e v}^{i}} {\sum }_{t = 1}^{{t}_{c}} {P}_{f a s t} {μ}_{m}^{i} \left(t\right)$$
wherein
$${P}_{c}^{a l l} \left(t\right)$$
is a total charging load of the target region, P
_{i,c}(t) is a charging load of a charging station i, and N_{ct} is a number of charging stations in the target region;
$${N}_{e v}^{i}$$
is a number of electric vehicles connected to the charging station i,
$${μ}_{m}^{i} \left(t\right)$$
is a charging mark of a vehicle m at the moment t, and P
_{fast} is fast charging power of an electric vehicle; and t_{c} is charging duration, in minutes.

3. The method according to claim 2, wherein a set of user’s candidate charging stations corresponding to the fast charging demand decision in step S13 is:
$$B = \left\{{S}_{1} , {S}_{2} , ⋯ \left|S O {C}_{n o d e - s}^{m} > S O {C}_{sec} , {T}_{i} < {T}_{L}\right)\right\}$$
wherein
$$S O {C}_{n o d e - s}^{m}$$
is a battery state of charge (SOC) when a user arrives at an optional charging station from a place where a charging demand is generated, and SOC
_{sec} is an electrical quantity constraint; Tᵢ =t_{goto} +t_{c} +t_{back} is a total time consumed, wherein t_{goto}, t_{c} and t_{back} are a time consumed for the user to go to a charging station, a time for charging, and a time for driving to a destination after charging, respectively; and T_{L} is a latest arrival time acceptable by the user.

4. The method according to claim 2, wherein the depicting fast charging demand decision and the spatial-temporal trajectory change of the user trip in step S13 comprises: traversing through trips of the electric vehicle in the target region based on the trip chain to calculate power consumption for each trip and the battery SOC, and determine whether charging is needed; if charging is not needed, proceeding to a next trip until all trip purposes are completed; if charging is needed, calculating a time when a fast charging demand of the electric vehicle is generated and a location where the fast charging demand is generated; planning a path to a nearest charging station by using Dijkstra algorithm, and updating a fast charging load of each charging station in the target region after charging.

5. The method according to claim 3, wherein the trip chain is represented as a whole trip process of a traveler’s trip from a starting point, through several destinations, and then back to the starting point, and comprises a spatial feature chain, a temporal feature chain, and a charging feature chain;
in the spatial feature chain,
$${d}_{k}^{m} \left({x}_{i} , {y}_{i}\right)$$
represents a geographical position of the vehicle m at a destination k and is denoted by two-dimensional rectangular coordinates;
$${L}_{{d}_{k} {d}_{k + 1}}^{m} \left(k = 0 , 1 , 2 , ⋯ {n}_{d}\right)$$
is a mileage of the vehicle m from
$${d}_{k}^{m}$$
to
$${d}_{k + 1}^{m} ,$$
and n
_{d} is a number of destinations comprised in the user’s trip in one day;
in the temporal feature chain,
$$t {s}_{{d}_{k}}^{m}$$
is a moment when the vehicle m leaves a stay point
$${d}_{k}^{m} ,$$
$$t {a}_{{d}_{k}}^{m} , t {r}_{{d}_{k}}^{m}$$
are a time when the vehicle m arrives at the stay point
$${d}_{k}^{m}$$
and a time when the vehicle is parked at the stay point, and
$${t}_{{d}_{k ,} {d}_{k + 1}}^{m}$$
is a total time spent for the vehicle m from the starting point
$${d}_{k}^{m}$$
to the destination
$${d}_{k + 1}^{m} ;$$
and
in the charging feature chain,
$$S O {C}_{{d}_{k}}^{m}$$
is a battery SOC when the vehicle arrives at the destination
$${d}_{k}^{m} ,$$
and
$$Δ S O {C}_{k , k + 1}^{m}$$
is a total battery SOC variation of the vehicle traveling from the destination
$${d}_{k}^{m}$$
to the destination
$${d}_{k + 1}^{m} ,$$
with a value being an algebraic sum of electrical quantity replenished from a charging station and electrical quantity consumed during the trip.

6. The method according to claim 1, wherein an expression of the weighted user charging location decision model in step S2 is:
$${X}_{W s} = min \left\{{ω}_{c} {C}_{i} + {ω}_{T} {T}_{i} + {ω}_{s o c} {C}_{S O {C}_{i}}\right\}$$
wherein Cᵢ, C_{Tᵢ}and C_{SOCᵢ}are a user charging cost, a time cost consumed by the user in selecting the charging station i, and a battery SOC cost consumed during the user’s trip under a same dimension, ω_{c}, ω_{T} and ω_{SOC} are weight coefficients corresponding to the three costs, respectively; and the user charging cost Cᵢ comprises an electricity price cost and a charging service fee cost.

7. The method according to claim 6, wherein quantitative expressions of the user charging cost Cᵢ, the total user time cost C_{Tᵢ}and the battery SOC cost C_{SOCᵢ}are:
$${C}_{i} = {ρ}_{i}^{t} {E}_{h} Δ E$$
$${C}_{{T}_{i}} = {θ}_{L} {T}_{i} = {k}_{t} {S}_{p} / {T}_{p} ⋅ {T}_{i}$$
$${C}_{S O {C}_{i}} = Δ S O {C}_{i} ⋅ {ρ}_{s l o w} ⋅ {E}_{h}$$
wherein
$${ρ}_{i}^{t}$$
is a charging service fee of the charging station i at the moment t, and ΔE is electrical quantity replenished for a single electric vehicle each time, and E
ₕ is a quantitative value of an electrical quantity of the electric vehicle; θ_{L} is a unit trip time value corresponding to a leisure time, with a unit of yuan/h, kₜ is a time value coefficient, Sₚ is an annual income of a worker, and Tₚ is annual working hours of the worker; ΔSOCᵢ is electrical quantity consumed during the user’s trip to charging, and ρ_{slow} is a charging price in a slow charging mode.

8. The method according to claim 1, wherein step S3 comprises the following substeps:
step S31: superposing a fast charging load obtained by using the fast charging load prediction model for electric vehicles and a basic load of a target distribution network to obtain a comprehensive load of each node of the distribution network, and constructing a graded charging service fee model for charging stations;
step S32: reducing the comprehensive load to corresponding power supply nodes of the distribution network, and calculating a voltage of each node of the distribution network by using a time sequence load flow; and
step S33: optimizing and adjusting the charging service fee based on an adjustment mechanism with the minimum sum of absolute values of voltage deviations of the nodes in the distribution network in the region as the optimization objective.

9. The method according to claim 8, wherein the graded charging service fee model for charging stations in step S31 is:
$$ρ = \left\{\begin{matrix}{ρ}_{1} & {P}_{min} \leq P \leq {P}_{1} \\ {ρ}_{2} & {P}_{1} \leq P \leq {P}_{2} \\ {ρ}_{3} & {P}_{2} \leq P \leq {P}_{3} \\ {ρ}_{4} & {P}_{3} \leq P \leq {P}_{max}\end{matrix}\right)$$
wherein p is a charging service fee; p1, p2, p3 and p4 are four levels of charging service fees, meeting ρₘᵢₙ≤ρ1<ρ2<ρ3<ρ4 ≤ρₘₐₓ, wherein ρₘᵢₙ is a lower limit of the charging service fee, and ρₘₐₓ is an upper limit of the charging service fee; P is a daily comprehensive load of power supply nodes for 24 hours; and Pₘᵢₙ and Pₘₐₓ are a minimum load and a maximum load in one day; and
a charging service fee grading boundary expression is:
$${P}_{i + 1} = {P}_{i} + Δ P$$
$$Δ P = \frac{{P}_{max} - {P}_{min}}{{n}_{p}}$$
wherein ΔP is a difference between upper and lower boundaries of adjacent charging service fees, and nₚ is a number of levels of charging service fees, and is set to 4.

10. The method according to claim 8, wherein the adjustment mechanism in step S33 is:
$$\text{Δ} {M}_{n , t}^{i} = \left\{\begin{matrix}- \left[\left|\text{Δ} {V}_{i , t}\right| / \text{Δ} {V}_{b}\right] \text{Δ} ρ & \left|\text{Δ} {V}_{i , t}\right| < 7 \% \\ 0 & \left|\text{Δ} {V}_{i , t}\right| = 7 \% \\ + \left[\left|\text{Δ} {V}_{i , t}\right| / \text{Δ} {V}_{b}\right] & \left|\text{Δ} {V}_{i , t}\right| > 7 \%\end{matrix}\right)$$
$${M}_{n , t}^{\left(i + 1\right)} = {M}_{n , t}^{i} - \text{Δ} {M}_{n , t}^{i}$$
where
$$\text{Δ} {M}_{n , t}^{i}$$
is a charging service fee adjustment quantity of a charging station n at the moment t during a
^{i^{th}}adjustment;
$${M}_{n , t}^{\left(i + 1\right)}$$
and
$${M}_{n , t}^{i}$$
are charging service fees of the charging station n at the time t after a
^{i^{th}}and i-1^{th} adjustment respectively; ΔV_{b} is defined as a unit voltage deviation, and Δρ is an adjustment stride of a unit deviation charging service fee; ΔV_{i,t} is a voltage per-unit value deviation of a node i in the distribution network at the moment t, with an expression of
$$\text{Δ} {V}_{i , t} = \frac{{V}_{i , t} - {V}_{b}}{{V}_{b}} ,$$
wherein V
_{i,t} is a node voltage per-unit value of the node i at the moment t, and V_{b} is a reference voltage per-unit value of each node; and [x] is rounding x.
